(19) United States
(12) Patent Application Publication
(10) Pub. No.: US 2026/0073611 A1
(43) Pub. Date: Mar. 12, 2026

(54) GENERATING A RENDERED IMAGE OF A THREE-DIMENSIONAL OBJECT

(71) Applicant: Sony Interactive Entertainment Europe Limited, London (GB)

(72) Inventors: Ioannis Andreopoulos, London (GB); Matthias Sebastian Treder, London (GB); Sebastian Alexander Lutz, London (GB); Pinaki Nath Chowdhury, London (GB); Jia-Jie Lim, London (GB)

(21) Appl. No.: 19/395,434

(22) Filed: Nov. 20, 2025

Related U.S. Application Data
(63) Continuation of application No. PCT/GB2024/051346, filed on May 24, 2024.
(60) Provisional application No. 63/503,975, filed on May 24, 2023.

(51) Int. Cl. G06T 15/00

(52) U.S. Cl. CPC G06T 15/00

(57) ABSTRACT

A computer-implemented method for generating a rendered image of a three-dimensional object. A meta-storage component is used, that contains at least two pre-constructed grids of three-dimensional data grid points corresponding to features of three-dimensional visual representations of a plurality objects or scenes. A selection code is received, that represents the shape and appearance of the three-dimensional object. An instantiation of the three-dimensional object is constructed, using a selector component, by querying the meta storage component using the selection code to retrieve at least one combination of at least two pre-constructed grids of three-dimensional data grid points from the meta-storage component. A rendered image of the three-dimensional object is then generated using the instantiation of the three-dimensional object.

### CROSS-REFERENCE TO RELATED APPLICATIONS

This application is a continuation of PCT Application No. PCT/GB2024/051346, filed on May 24, 2024, which claims priority to U.S. Provisional Application No. 63/503,975, filed on May 24, 2023, the disclosures of which are incorporated by reference.

### TECHNICAL FIELD

The present disclosure concerns computer-implemented methods of generating rendered images of three-dimensional objects.

### BACKGROUND

Traditional rendering techniques rely on explicit representations of 3D geometry and materials, and they have been the main workhorse of computer graphics for the past three decades. However, such pipelines can be computationally expensive and require significant manual effort to create visually appealing assets. Recent years have seen the rise of implicit neural rendering techniques such as Neural Radiance Fields (NeRFs). They provide a powerful alternative approach to rendering that uses a neural network to learn a continuous volumetric representation of a scene, allowing for potentially more efficient and flexible rendering. However, training conventional implicit models requires a large amount of data, is computationally expensive, without easy customization and modification, limiting their practical use. For every object or visual scene, a dedicated set of images along with camera parameters is required.

Spatially localised feature grids have been used, for instance in the shape of hash grids or sparse voxel grids. However, the existing techniques are all spatially rigid with a fixed hierarchy of co-localised, overlapping grids. Most importantly, they only allow for the storage of a single visual object or scene. They also offer no complex selection process, instead relying on a linear interpolation between grid points and a spatially uniform stacking of all features. An attempt to generalise implicit neural representations to multiple objects and scenes has been made in a model that can synthesise 3D views from one or a few input views by extracting multiple pixel-based features using a convolutional neural network (CNN). Although such a model shows good generalisation capabilities for few views it has disadvantages. Firstly, although it can produce novel 2D views it does not output an actual neural 3D asset. Instead, an associated pipeline has to be used to render novel views. Secondly, it always needs to be conditioned on 2D input views. It is not truly generative in that it cannot produce novel object shapes from a random latent code. In summary, it cannot universally represent shapes and generate new shapes in a training-free fashion. Thirdly, such a model can only produce static assets and is not able to produce the corresponding motion primitives.

For more traditional image representations such as point clouds and meshes, significant progress on AI-based asset generation has been made. For instance, an AI model that generates assets from text input outputs point clouds that can then be converted to meshes. Similarly, high-fidelity meshes and corresponding texture maps have been generated from randomly sampled latent codes. Another model uses stable diffusion to generate 3D point clouds from single views. However, such existing models produce explicit assets, that is, they are not able to produce implicit neural models.

The present disclosure seeks to solve or mitigate some or all of these above-mentioned problems. Alternatively, and/or additionally, aspects of the present disclosure seek to provide improved methods of generating rendered images comprising three-dimensional objects.

### SUMMARY

In accordance with a first aspect of the present disclosure there is provided a computer implemented method for generating a rendered image of a three-dimensional object, using a meta-storage component that contains at least two pre-constructed grids of three-dimensional data grid points corresponding to features of three-dimensional visual representations of a plurality of objects or scenes, the method comprising:
receiving a selection code representing the shape and appearance of the three-dimensional object;
constructing, using a selector component, an instantiation of the three-dimensional object, by querying the meta storage component using the selection code to retrieve at least one combination of at least two pre-constructed grids of three-dimensional data grid points from the meta-storage component; and
generating a rendered image of the three-dimensional object using the instantiation of the three-dimensional object.

This provides an improvement on known rendering methods by allowing rapid, training-free generation of implicit neural assets. The training process required for individual assets can be circumvented, by storing knowledge about visual features of a very large number of objects in a meta storage consisting of elastic data grids. A nonlinear selector can select, combine, modify and post-process the stored features in a potentially spatially non-uniform way. Furthermore, a dedicated training pipeline can allow for the dissociation of visual aspects (e.g., shape, texture, colour) into separate dimensions, allowing for maximum flexibility and recombination.

Embodiments of the presently disclosed methods can have two key aspects:
(i) Generation of implicit neural assets. Unlike previous generative approaches that return 3D assets in the form of triangulated meshes or point clouds, embodiments of the presently disclosed methods return implicit neural assets, that is, neural-based continuous representations of the object or scene to be modelled.
(ii) Training-free. Embodiments of the presently disclosed methods allow for the instantaneous representation and creation of neural assets without the need for neural network training or fine-tuning, although fine-tuning on a specific target domain can be used to increase diversity, detail, or image resolution.

Embodiments of the presently disclosed methods can have numerous application domains and instantiations in the fields of computer graphics and virtual and augmented reality. Of primary interest are use in generating realistic and interactive virtual environments and assets for gaming and simulation, creating high-quality product visualisations for e-commerce, and facilitating faster design iterations in engineering and architecture. Additionally, they can be used to generate synthetic training data for machine learning algorithms, reducing the need for manual labelling and annotation.

In embodiments, the pre-constructed grids of three-dimensional data grid points of the meta-storage component are constructed using an artificial neural network, ANN, by training the features of the three-dimensional data grid points using a database of three-dimensional images of three-dimensional objects using stochastic gradient descent and at least one of the following loss functions: photometric loss, perceptual loss, volumetric loss, sparsity-inducing density loss, GAN loss, VAE loss, depth loss, grid elasticity regularisation loss.

In embodiments, the features of the three-dimensional data grid points are trained using a database of two-dimensional images or videos containing at least one of RGB data, depth data, RGB-D data, and the training uses, in addition to the loss functions, a set of camera parameters provided by one: camera sensors; inference by a numerical fitting process that estimates the camera parameters from available training data; and computer software that generates artificial two-dimensional images with associated camera parameters.

In embodiments, the selection code is generated using an ANN. The ANN may use a generative model with at least one of Generative Adversarial Network (GAN), Variational Autoencoder (VAE).

In embodiments, the step of receiving the selection code comprises generating the selection code from at least one input image. The least one input image may comprise a two-dimensional view of the three-dimensional object. The selection code may be constructed by encoding the least one input image, and wherein the encoding is obtained from at least one intermediate layer of an ANN trained for a computer vision task. The encoder may use an external image embedding model.

In embodiments, the instantiation of the three-dimensional object is a Neural Radiance Field. In other embodiments, the instantiation of the three-dimensional object is a Signed Distance Function.

In accordance with another aspect of the disclosure there is provided a computing device comprising:
a processor; and
memory;
wherein the computing device is arranged to perform using the processor any of the methods described above.

In accordance with another aspect of the disclosure there is provided a computer program product arranged, when executed on a computing device comprising a processor or memory, to perform any of the methods described above.

It will of course be appreciated that features described in relation to one aspect of the present disclosure described above may be incorporated into other aspects of the present disclosure.

### DESCRIPTION OF THE DRAWINGS

Embodiments of the present disclosure will now be described by way of example only with reference to the accompanying schematic drawings of which:

FIGS. 1(a) to 1(c) are schematic diagrams showing a neural network in accordance with embodiments;

FIG. 2 is a schematic diagram showing a neural network in accordance with embodiments;

FIG. 3 is a schematic diagram showing a neural asset generator in accordance with embodiments;

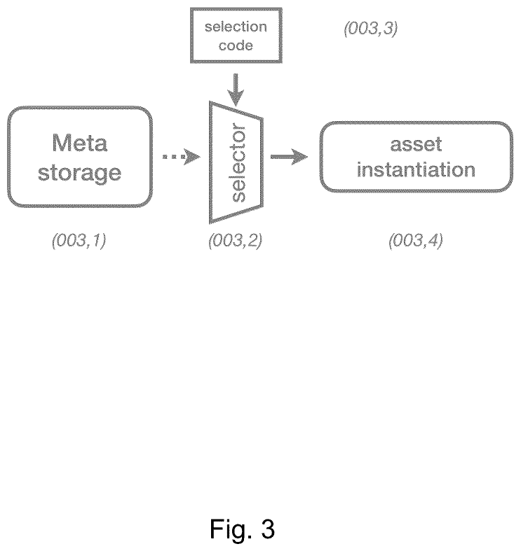

FIG. 4 is a schematic diagram showing an more detail meta storage and selector of the neural asset generator in accordance with embodiments;

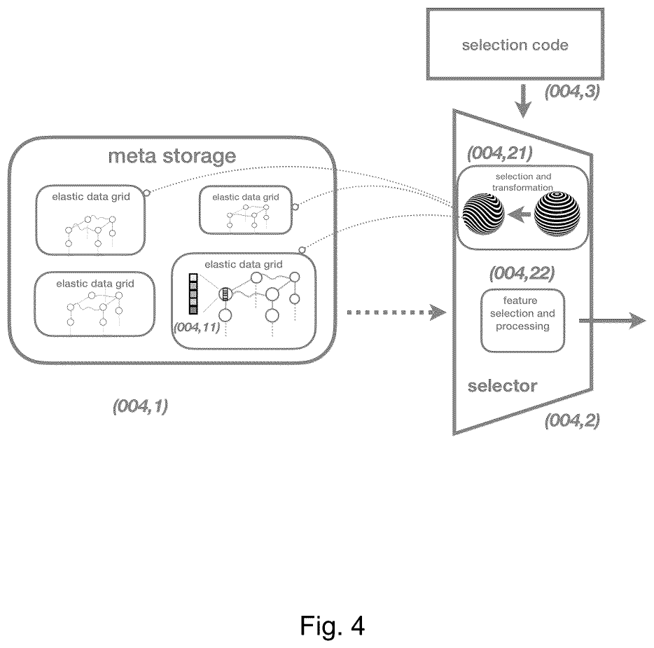

FIG. 5 is a schematic workflow diagram showing an example training process in accordance with embodiments;

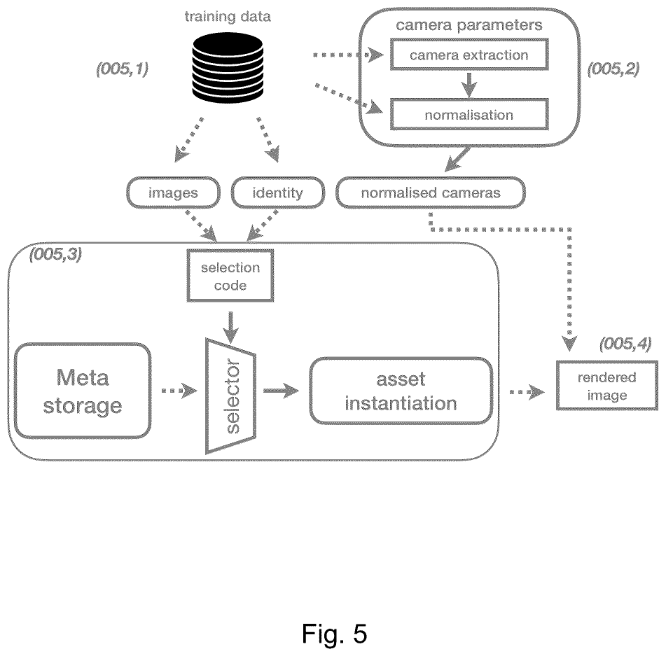

FIG. 6 is a schematic workflow diagram showing an example inference process in accordance with embodiments;

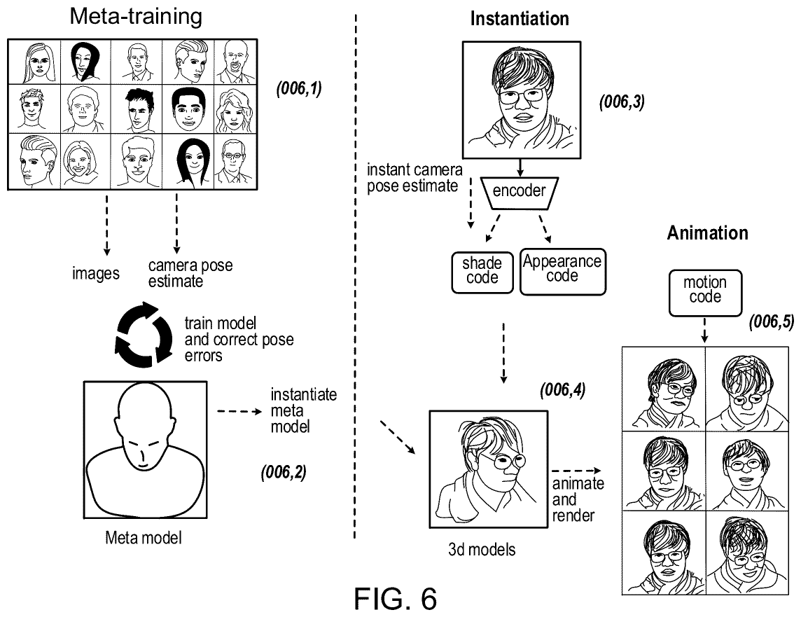

FIG. 7 is a flowchart showing the steps of a method of generating a rendered image of a three-dimensional object in accordance with embodiments; and

FIG. 8 is a schematic diagram of a computing device in accordance with embodiments.

### DETAILED DESCRIPTION

The presently disclosed methods provide for the representation, approximation, manipulation, and/or generation of implicit neural 3D assets. The assets can take the form of Neural Radiance Fields (NeRFs), related techniques such as Signed Distance Functions or Neural Radiance Caches, or other neural network based representations of the visual structure of a scene. Examples for the generated neural assets include human head avatars, full-body avatars, other living or non-living objects (e.g., a 3D bathtub representation), collections of multiple such objects, or whole scenes consisting of multiple objects and their spatial arrangements (e.g., a bathroom scene). In addition to static assets, dynamic, time-evolving assets are generated by applying and combining motion primitives extracted from the training data.

Embodiments of the presently disclosed methods comprise the following two main components:
1. Meta storage (003,1), a component that compiles the combined knowledge the model has about visual assets, i.e. objects, either general purpose assets or assets of a specific target domain (e.g. visual representations of furniture)
2. Selector (003,2), an approach that queries the meta storage using a selection code representing shape and appearance of the target asset (003,3) and then constructs the concrete instantiation of the target asset (003,4)

The meta storage is a representation of the cumulative knowledge about 3D assets or about assets pertaining to a specific target domain (003,1). Target domains can be any discernible grouping of visual assets, e.g. faces, heads, bodies, chairs, or more generally furniture, or living or non-living objects. The model acquires this knowledge via a training process elucidated below. The information is stored in an elastic meta grid with grid points defined in 3D world space. Different aspects of assets (e.g. shape, density, texture, colour) are stored in different dimensions of the elastic grid, allowing for a decorrelation of visual features and maximal expressiveness via free recombinations of shapes and colours. Crucially, the meta grid is non-Euclidean, high-dimensional, adaptive, potentially sparse, and elastic via a flexible hierarchy with spatial relationships between the different grid levels being not rigid but rather modified by spatial transformations. Adaptivity is assured during the training process (see below) which shapes the grid topology such that spatial regions with more information density are matched with a more dense data grid. At inference time, the grid can be squeezed and stretched via elasticity transformations in order to match the target asset. These transformations can involve simple rigid body transformations such as translation, rotation, and scaling, or more elaborate non-linear warp operations, potentially represented by an auxiliary coordinate transformation model. In addition, sparse grids can be learned by dropping out grid points in regions that are either empty or have constant colour and density, and creating grid points in regions with fine details.

Dynamical assets (e.g. object deformations, animated scenes, or talking head avatars) can be implemented by employing a collection of meta storages. The collection is then indexed and linearly combined using a weight vector. The weights are distilled out of the selection code.

Assets are retrieved and synthesised out of the meta storage (004,1) using a generally non-linear selector (004,2). The selector indexes, fuses, and transforms the features stored in the meta storage. The selector is programmed via a selection code that provides information about the target asset's shape and appearance (004,3). The code enables the selector to steer the spatial transformations defining the relationships between the different levels of the elastic grid. The selector can do so in a spatially non-uniform way, that is, it receives the target coordinates in world space and thus performs a spatially adaptive selection. Once features are selected and fused into vectors, they undergo an either linear (change of basis) or more generally non-linear recombination and transformation process that aims to produce assets with the desired shape and appearance properties. Importantly, the output of the selector is also an implicit neural model. This implies maximal reusability of the generated asset in downstream applications (e.g. neural rendering frameworks), application of conversion algorithms (conversion to point clouds, voxels, or mesh grids), as well as seamless integration of acceleration structures such as octrees and bitrate reduction techniques.

### Neural Network Architectures

As embodiments of the presently-disclosed methods use neural network architectures and training with back-propagation and stochastic gradient descent, we elaborate on example embodiments of these architectures and training in this part. We note that whenever the term ‘training’ or ‘learning’ is used, it refers to adjusting neural network weights (such as: a multilayer perceptron or a convolutional neural network weights) or other parameters (such as: feature parameters, embeddings, or function parameters) via backpropagation and stochastic gradient descent. The nature of backpropagation and stochastic gradient descent is described in the embodiments found below. Similarly, the term ‘pretrained’ means that a model has been trained on a different dataset prior to usage in our approach. A pretrained model can either be used directly, or its weights can be continued to be trained (in general, on a different dataset) along with the other components of our framework. The latter procedure is called ‘fine-tuning’.

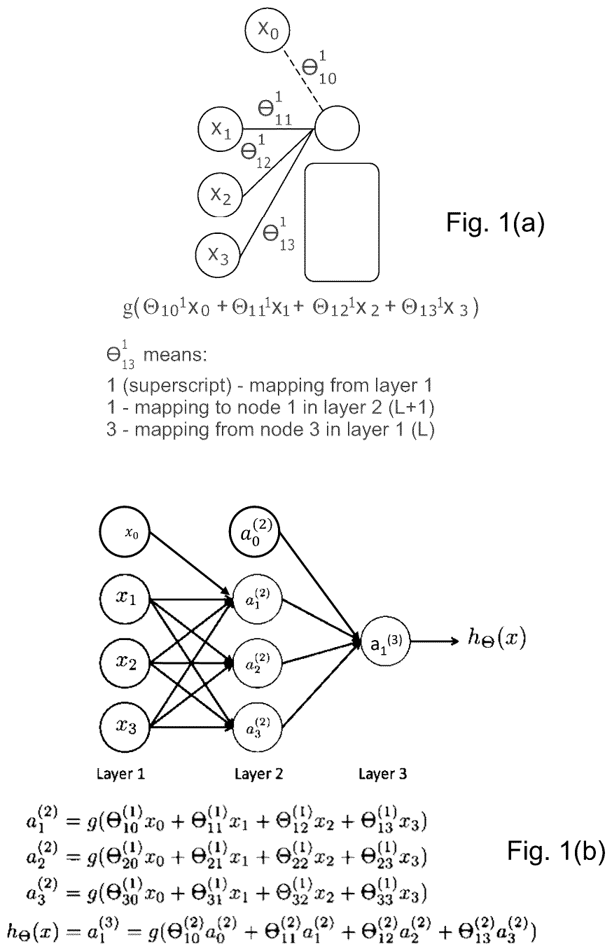

An example embodiment of utilized neural network weights is provided in FIG. 1(a). An associated instantiation in FIG. 1(b) showcases global connectivity between weights and inputs. An instantiation of local connectivity between weight θⱼᵢ connecting input αᵢ and output αⱼ is shown in FIG. 1(c) for one of the computations of a convolution. The activation function applied to produce output αⱼ is shown by g(zⱼ), and it can comprise a parametric ReLU (pReLU) function, or another non-linear function like ReLU or sigmoid or other. FIG. 1(c) also shows connections from output αⱼ to the next-layer outputs via weights θ₁ᵢ, θ₂ᵢ, . . . , θₖᵢ. It also illustrates how back-propagation based training can feed errors from outputs back to inputs. The illustrated errors are indicated by δ₁, δ₂, . . . , δₖ, and they are computed from errors of subsequent layers, which, in turn, are computed eventually from errors between network outputs and training data outputs that are known a-priori. In the presently disclosed methods, such a-priori known outputs comprise test 2D or 3D images, meshes, point cloud data or precomputed features, with the distinction between them provided by the context. These are given as input training data and the network outputs comprise the inferred outputs that attempt to approximate the provided ones. The errors between network outputs and training data are evaluated with a set of functions, termed “loss functions”, which evaluate the network inference error during the training process using appropriate loss or cost functions to the problem at hand. More details on instantiations of neural networks and loss functions within the presently disclosed methods are provided in the related parts of the description. If the training data is just input data and the network starts from such data and is designed to derive a compact feature representation and then expand it to reconstruct the input data, the process of training is also termed as ‘self-supervised’ training or autoencoder training or feature extraction from the compaction stage of the neural network architecture, where no external ‘labels’ or annotations or other external metadata are needed for the training data.

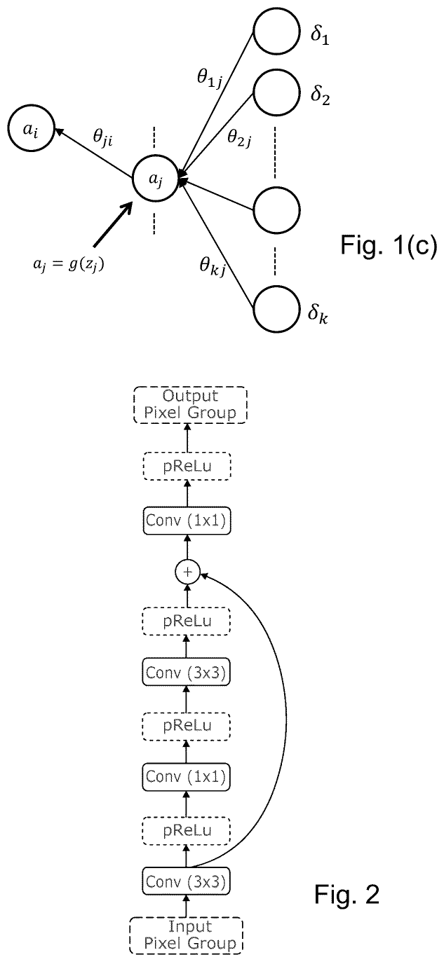

Embodiments of encoding of the input into a compact latent representation and generation of the reconstructed signal from a latent representation involve convolutional neural networks (CNNs) consisting of a stack of convolutional blocks (conv blocks), as exemplified in FIG. 2 and stacks of layers of fully-connected neural networks of the type shown in FIG. 1(b). As before, in some embodiments, the convolutional blocks can include dilated convolutions, strided convolutions, down/up-scaling operations (for compaction and expansion, respectively, also termed as convolution/deconvolution), normalisation operations, and residual blocks. In certain instantiations, the CNN includes a multi-resolution analysis of the image using a U-net architecture. The output of both CNNs can be either a 2D or 3D feature block (or reconstructed 2D image or 3D video frames, or feature layers composed of features from a graph convolution step, or a 1D vector of features. In the latter case, the last convolutional layer is vectorised either by reshaping to 1D or alternatively by using a global pooling approach (i.e., global average pooling or global max pooling). In such cases, the dimensionality of the vector is the number of channels in the last convolutional layer. If the output is 1D, the vectorisation is typically followed by one or more dense layers [FIG. 1(b)]. Finally, some embodiments of CNNs and fully-connected neural networks trained to predict the next output and operating within a window of inputs and intermediary features form what is known as an “attention” module, with common instantiations of this module being called a “transformer”. In the presently-disclosed methods, some or all of these components are used in embodiments of the different components when the terms “neural network” or “training” are used.

### Components of the Presently Disclosed Methods

The meta storage (004,1) holds the entire information distilled from the dataset it was trained on. It consists of an ensemble of elastic data grids with grid points referring to points in 3D space. Each data grid is a non-Euclidean and non-uniform set of points governed by

$$\{ ( {x}_{i} , {y}_{i} , {z}_{i} ) \vert {x}_{i} \geq {x}_{i - 1} , {y}_{i} \geq {y}_{i - 1} , {z}_{i} \geq {z}_{i - 1} \} \qquad ( Eq . 1 )$$

where x₀=xₘᵢₙ, y₀=yₘᵢₙ, z₀=zₘᵢₙ designating the lower left border of the coordinate space.

A special case of this is the uniform grid

$$( {x}_{i} , {y}_{j} , {z}_{k} ) : = ( {x}_{min} + i * {δ}_{x} , {y}_{min} + j * {δ}_{y} , {z}_{min} + k * {δ}_{z} ) \qquad ( Eq . 2 )$$

with grid spacing along the x, y, and z directions given by δₓ, δ_{y}, and δ_{z} respectively. To store information at different resolution levels, both coarse grids (with large spacing between grid points) and fine grids are used simultaneously. In each grid point, feature vectors are stored that describe the shape and appearance of objects. Since the meta storage has been trained on numerous objects simultaneously, the information is somewhat more abstract and needs to be post-processed and further sub-selected to produce a concrete visual asset. This information is distributed across the different entries within feature vectors as well as across multiple grids.

A naive implementation of the elastic grid requires N*B bytes per data grid, where N is the number of points and B is the number of bytes in each feature vector. Even for medium sized coordinate spaces (e.g. 256³), the data grid can consume a large amount of memory. Additionally, the grid coordinates may have to be stored for lookup. Therefore, more efficient data structures can be employed to reduce the amount of memory usage. For instance, Hash grids store feature vectors in a fixed-size hash table. Entries are accessed via a hash function based on the queries coordinates. Hash tables lower memory consumption but this comes at the expense of hash collisions, i.e., different grid points accessing the same table entry. This problem can be mitigated by replacing the hash table by learnable indexing.

Whereas the meta storage is a versatile but passive data structure describing a whole range of 3D visual assets, the selector is its active counterpart that is responsible for the storage and retrieval of information in the meta storage and the instantiation of a concrete asset (004,2). To perform this task, it receives a selection code describing the shape and appearance of the target object or scene. The selector operates in two stages.
1. A selection and transformation component (004,21). It extracts transformation instructions from the input code on the basis of which transformations are performed on the elastic grids in the meta storage component. These operations include scaling, rotation, translation, but also coordinate specific (i.e., spatially non-uniform) warping operations. These operations are grid-specific and individually applied to each data grid. This is necessary to assure a high expressiveness and generalizability of the information in the meta storage to unseen data. Once all elastic grids have been modified, they are returned to the selector.
2. A feature selection and processing component (004,22). It further processes the transformed elastic grids. Its main task is to reorder, select, merge, and process the received features in a reductive fashion such that the output feature grid is lightweight and has only the knowledge corresponding to the target object. All other meta knowledge pertaining to other objects is distilled out. To guide this process, shape and appearance information contained in the selection code is used. Several examples for selection algorithms in ascending order of complexity and expressiveness are provided below:
   a. Global linear combination: Let ξ∈ [symbol] be the selection code of dimension S, and ψₘₑₜₐ∈ [symbol] be a feature vector of dimension F stored in an elastic data grid of the meta storage. Define ƒ: [symbol] → [symbol] , w=ƒ(ξ) the weights and ψₒᵤₜ=Σᵢwᵢ ψ_{meta,i} the output feature following a linear combination of the inputs. Optionally, non-negativity of w can be enforced via a softmax operation. Multiple combinations can be formed to create multiple output features.
   b. Local linear combinations: Each elastic data grid is endowed with its own set of weights represented by functions ƒ₁, ƒ₂, . . . , ƒ_{G} and corresponding sets of weights w⁽¹⁾, w⁽²⁾, . . . , w^{(G)}. In other words, a different linear combination of functions is applied to each of the elastic grids. Typical embodiments of these functions comprise MLPs with parameters learnable by backpropagation and stochastic gradient descent. The resultant linear combinations can be thought of as selecting visual building blocks from the meta storage (e.g. a rough red colour texture for a sofa) that are put together to compose the target object.
   c. Global non-linear combination: Let φ_{ξ}: [symbol] → [symbol] be an arbitrary function mapping an F-dimensional feature onto a scalar output feature. The subscript ξ indicates that these functions depend on the selection code. Multiple outputs can be realised by instantiating multiple functions φ₁, φ₂, . . . . Local combinations can be realised via different sets of functions for different elastic grids. Typical embodiments of these functions comprise MLPs with parameters learnable by backpropagation and stochastic gradient descent. The resultant non-linear combinations can be thought of as selecting visual building blocks from the meta storage and then combining them in a non-linear way in order to compose the target asset.
   d. Spatially adaptive non-linear combinations: The functions in c are spatially uniform, that is, the same selection process is performed at each spatial location. To make selections spatially aware, the function can be additionally conditioned on several input coordinates (x,y,z), leading to functions of the form φ_{ξ|(x,y,z)}: [symbol] × [symbol] → [symbol] .
   e. Grid recombinations: So far, the different elastic grids have been treated as separate entities. Allowing for merging and recombining of information across different data grids, more flexible functions of the form φ_{ξ}: [symbol] × [symbol] × [symbol] × . . . → [symbol] where × represents the Cartesian product over the feature vectors from the different elastic grids. For notational convenience, it is assumed that the feature vectors are all of dimension F. Typical embodiments of these functions comprise MLPs with parameters learnable by backpropagation and stochastic gradient descent.
The functions ƒ₁, ƒ₂, . . . and φ_{ξ}, φ₁, φ₂, . . . can be represented by multi-layer perceptrons or other neural architectures such as attention models and trained in an end-to-end fashion along with the other components of the model.

The selection code drives the selection and retrieval process of the selector (004,3). It is a semantic encoded description of the to-be-generated object or scene, its location in the visual scene, shape, and appearance. The selector also uses the code to determine how to transform and combine the elastic grids and perform selection and creation of the output features. The code can come in different forms:
1. Explicit linear embedding: During the training process, an embedding is learned for each individual object in the training set. The entries of the embedding explicitly encode actions for the selector. For instance, let ξ=[s₁, t₁, q₁, w₁, . . . , s_{M}, t_{M}, q_{M}, w_{M},] where s (scaling scalar), t (translation vector), and q (rotation quaternions) describe the transformation of an elastic grid and the subscript indices the corresponding elastic grid 1≤i≤M. The vector w specifies the linear combination coefficients required to produce the output feature from the input features.
2. Implicit embedding: Rather than explicitly encoding operations on the elastic grids, the embedding vector represents a compressed or otherwise entangled representation of these operations. The selector then uses multi-layer perceptrons ƒₛ, ƒₜ, ƒ_{q}, ƒ_{w} to extract the desired quantities e.g.:

$$s = {f}_{s} ( ξ ) , t = {f}_{t} ( ξ ) , q = {f}_{q} ( ξ ) , w = {f}_{w} ( ξ ) .$$

3. Encoding model: embeddings (whether implicit or explicit) do not allow for the application of the selector to previously unseen objects. The solution is to use an encoding model instantiated by a deep neural network of sufficient capacity (e.g., ResNet-50) whose task is to analyse one or more input images and produce a corresponding selection code. Let I be the image(s) and E an encoding model, then ξ=E(I) produces the desired code. Such an encoding model can be trained in an end-to-end fashion along with the other components of the asset generator.
4. Generative manifold code: to generate novel assets, a method is required to generate meaningful but novel selection codes ξ. Such codes must be made sure to sample the manifold of selection codes. One such approach is Generative Adversarial Networks (GANs). A generator is trained to produce selection codes ξ=G(r) from randomly sampled vectors r. The generator is trained in conjunction with a discriminator model D(I) that maps an image/(real or rendered) to the probability that it is real. The GAN can be trained in conjunction with the rest of the model by adding a GAN loss function. An alternative approach is Variational Autoencoders (VAEs), whereby the encoder maps the data onto a latent space from which data is sampled for the decoder. Note that the encoder needs to be trained end-to-end with the selector and meta storage and that the latter serve as the decoder in the case of VAEs.

All of the aforementioned models are implemented as neural networks. To obtain the corresponding weights of the model, a training procedure involving a training dataset, model architectures and parameters, loss functions, an adequate training approach is explicated next. All components outlined earlier can be trained simultaneously in an end-to-end fashion. Different choices for components (e.g. the specific selector) may lead to modifications in loss functions and regularisation approaches. Training involves the following steps:
1. Extract training data (005, 1). The model is data agnostic and as such can be trained on arbitrary classes of data (e.g., images of human heads, furniture, natural scenes etc.) or even all classes combined. The data consists of either volumetric (i.e., 3D) images consisting of voxels or 2D images consisting of pixels. In the latter case, the data consists of either single-view images (one image per individual object), multi-view synchronous images (object recorded at the same time from multiple cameras), or multi-view asynchronous images (object recorded at different time points from either the same or multiple cameras), as well as labels signifying the identity. For single-view images, each image file has its own identity. For multi-view data, each collection of images of the same object receives the same identity label. The 2D images are supposed to contain either three color channels (RGB data), or depth only, or three color channels plus a depth channel (RGB-D data).
2. Selection code generation (005,2). Based on the images and identity labels, selection codes are created. These can take any shape or form as described in the section on selection codes. In other words, either the identity label is used to index a learnable explicit or implicit embedding, a generator is used to create a novel selection code ξ, or the input image is passed through an encoder model that generates a code representing the shape and appearance code of the displayed object.
3. Camera parameters (005,3). In order to train the model on a collection of different objects, the training assets can be provided as volumetric data. Alternatively, if only 2D views of the 3D assets are available, camera intrinsics and extrinsics (the position of the camera relative to the object) must be known for each of the 2D views. Moreover, a common coordinate system must be defined wherein all the different objects are placed. Embodiments of the presently disclosed methods are able to autonomously extract camera parameters from a set of 2D views. The camera parameter extraction can be broken up into two steps:
   a. Camera extraction. If multi-view data is available, standard techniques exploiting motion parallax between background and foreground such as COLMAP can be used. However, COLMAP is unreliable if the data is dynamic. For single-view data, one approach is to use object detectors that provide 3D bounding boxes. These bounding can then be reparameterized into camera parameters. The disadvantage of this approach is that it relies on pretrained object detectors, but such detectors may not be available for each object class and they may not detect objects with unusual shapes (e.g. imagine a chair in the shape of an animal). For the special case of head avatars, head pose estimation is used to extract yaw, pitch, and roll of the head. We then reparameterize these quantities into a rotation matrix and translation vector describing a camera in a canonical, object-centred coordinate space.
   b. Normalisation: Considering the camera poses for individual objects are either provided or inferred using the approaches in step (a) of (005, 3), it is unlikely that the spaces are co-registered and co-located. For example, traditional approaches in COLMAP produce idiosyncratic coordinate spaces that differ for different sets of multi-view images. In order to realise a common coordinate space, a homogenisation approach is required. A multi-stage approach is used:
      i. In the first stage, we compute a common upwards direction of all camera poses in a set. A rotation matrix is then computed such that all cameras are aligned to have the same upwards direction. Next, to align coordinate spaces across multiple datasets, we find matching camera poses (yaw, pitch, roll) between two sets of multi-view images. Next, we compute a translation matrix (one for each set) that minimises the Euclidean distance between the translation vector of the matching camera poses.
      ii. In the second stage, for the special case of head avatars, using the image (for translationally aligned camera poses) as input we extract face landmarks to get a face mesh. Next, we compute a mesh signature by computing the L2 distance between each pair of vertices in a mesh to get a N×N matrix. Next, we normalise the L2 distances to a unit scale to make the mesh signature dependent only on pose and not on the absolute dimensions of the mesh. We claim that images having similar mesh signatures should have similar rotation (yaw, pitch, roll). Accordingly, we compute mesh signatures from multiple images of each face to find matching head poses across datasets. Using matching head pose (and its corresponding camera pose), we compute a rotation matrix to rotationally align the datasets.
      iii. In the third stage, a rescaling is performed in order to assure that the same units are used for different objects. This is necessary since the units stemming from techniques such as COLMAP are not physical but data driven and can be inconsistent across datasets. In particular, we use the pre-computed mesh in the previous step (prior to applying unit normalisation). We readjust the camera pose-either bring them closer/away from the centre such that the size of mesh is consistent across datasets. This has two benefits: first, it ensures all objects are of the same scale which makes it easier for NeRF to learn, resulting in high-fidelity. Second, it adjusts for the fact that some datasets are captured by moving the camera too close to the face while others are captured from far away.
      iv. While the aforementioned stages can approximately align the camera poses from different datasets, it does not guarantee an exact match required for training models like NeRF, Implicit, or Explicit functions. To achieve the final stage of pose correction, we use bundle adjustment by learning a correction/displacement parameter for each camera
      v. As an alternative to the second stage, using images with translationally aligned camera poses as input, we extract keypoint landmarks (i.e., 2D coordinates and a local feature vector) using a custom version of SuperPoint, described in detail in the next step. Using the predicted keypoint features, we select pair of images from different datasets that satisfy the following constraints:
         Have at least 700 matching keypoints where the cosine distance of their features is less than a data-dependent threshold.
         We compute the Delanoy triangulation (similar to [Sarlin et al., 2020]) using the matching keypoints in each image. The triangulation is provided as input to a Graph Neural Network to compute a pose feature.
         Alternatively, we add positional encoding with each keypoint feature and input it into a self-attention transformer network [Vaswani et al., 2017]) to compute a pose feature.
         We compute the cosine distances of all pairs of pose features and select the image pairs with minimum distance.
         Using matching head pose and its corresponding camera pose, we compute a rotation matrix to rotationally align the datasets.
      vi. We now describe the custom adaptation on top of SuperPoint. Naive SuperPoint detects landmarks everywhere in the scene. Hence, to restrict SuperPoint to the subject of interest (and not background regions) we additionally add an instance segmentation network [He et al., 2017] and a depth-map predictor [Ranftl et al., 2021]. This yields pixel-wise semantic information alongside depth maps. We then identify the region that is characterised by low depth and simultaneously coincides with the instance segmentation mask. This is considered as the region of interest for sampling using SuperPoint.
4. Forward pass and rendering (005,3)-(005,4). The generated selection code is used to query and transform the meta storage and then select and process the resultant features using the selector. The selector then returns a neural asset that represents a 3D scene or object. In order to ensure the quality of the generated asset, the produced asset has to be compared against the training data. If the training data consists of 3D images, they can directly be compared to the produced assets. If instead only 2D images of the 3D assets are available, corresponding 2D views of the generated assets are produced and compared against the training images. The latter can be done using a known volume rendering approach. In this approach, rays are cast through each pixel of the resultant image starting from a common origin. Let a ray through one of the pixels be represented by the equation r(t)=o+td, where o∈ [symbol] is the ray's origin, d∈ [symbol] is its direction and t∈ [symbol] represents its length. Origins and directions are determined by the sampled camera extrinsics and intrinsics. Let n and f be the near and far bounds, then the colour C of the pixels can be obtained by

$$C ( r ) = {\int }_{n}^{f} T ( t ) σ ( r ( t ) ) c ( r ( t ) , d ) dt \qquad ( Eq . 3 )$$

where c(r(t), d) is the RGB colour at location r(t) with the argument d allowing for view-dependent effects such as reflections, σ(r(t)) is the density of the volume, and T(t) denotes the accumulated transmittance along the ray representing the probability that the ray travels the length t without hitting a particle, given by

$$T ( t ) = exp ( - {\int }_{n}^{f} σ ( r ( s ) ) ds ) . \qquad ( Eq . 4 )$$

We can further combine T and σ as

$$w ( t ) = T ( t ) σ ( r ( t ) ) \qquad ( Eq . 5 )$$

For application in a real world dataset, this equation is discretized into typically 128 or 256 points along each ray, and the integral is replaced by a weighted sum. Repeating this process for every pixel yields a full 2D image of the neural asset. Crucially, C(r) is differentiable, which means that a loss calculated on the output images can be backpropagated through the entire model using stochastic gradient descent. Note that for novel generated assets stemming from the selection code generator, no camera extrinsics are available. In this case, the camera position is sampled from a unit sphere centred at the object with the camera pointing at the origin.
5. Loss functions. The learnable parameters of the overall model are randomly initialised at the start of training and then iteratively updated using backpropagation. Learnable parameters include the learnable embeddings or encoder model producing the selection code, the neural network components underlying the selector, and the contents of the elastic grids and the 3D grid positions. If a generative model is included, additional neural networks representing generator and discriminator are included in the training loop. The weights of these parameters are updated using the following loss functions:
   a. Photometric loss. Image I is compared to rendered image I pixel-wise using an L2 loss, L_{photometric}(I, Ĩ)=|I−Ĩ|₂. For neural assets generated by the selection code generator, no target images are available and a GAN loss is used instead of the photometric loss.
   b. Perceptual loss. A perceptual model P maps an image onto a set of features. Typically, these features are different layers from a convolutional neural network trained on ImageNet data. L2 loss is then calculated between the features of input and rendered image. Perceptual loss is less focused on pixel-wise correspondences and more on structural and human perceptually relevant correspondences: L_{perceptual}(I, Ĩ)=|P(I)—P(Ĩ)|₂.
   c. Volumetric loss. If volumetric image data is available, it can directly be used for loss calculation without need to resort to a differentiable renderer. An L2 volumetric loss is given by L_{volumetric}(J, Ĵ)=|J−Ĵ|₂, where J is the volumetric training image and Ĵ is the 3D rendering of the asset.
   d. Sparsity-inducing density loss. If a segmentation mask M differentiating background and foreground is available, an additional density loss can be applied that encourages the model to place density only in areas occupied by the target object: L_{density}(M, T)=|M−(1−T)|₁, where M is the binary mask and T the accumulated transmittance in Eq. 4.
   e. GAN loss. In order to be able to generate novel unseen assets, the selection code generator G has to be trained and the discriminator D is trained to discriminate between real and generated assets. Denoting the neural asset generator as N and the renderer as R, we obtain the minimax loss

$${L}_{GAN} = {E}_{I ∼ train} [ log ( D ( I ) ) ] + {E}_{z ∼ rand} [ log ( 1 - D ( R ( N ( G ( z ) ) ) ) ] ,$$

where I˜train are the training images and z˜rand are the randomly sampled vector driving the generator.
f. VAE loss. If a Variational Autoencoder (VAE) is used instead of a GAN to generate the selection code, its encoder outputs vector x=[μ, σ] representing mean u and covariance σ of a multivariate normal distribution. A divergence loss is then used to regularise the space x, L_{VAE}(x)=KL( [symbol] (μ, σ)| [symbol] (0, I)), where KL represents Kullback-Leibler divergence and [symbol] (μ, σ) represents the normal distribution with mean μ and covariance matrix σ, and I is the identity matrix.
g. Depth loss. If depth priors P_{d} are available, either stemming from RGB-D data, monocular depth estimates, or multi-view depth reconstructions using approaches such as COLMAP, depth supervision can be applied to further constrain object geometry: L_{depth}(P_{d}, [symbol] )=|P_{d}− [symbol] |₁
   where

$$= {\int }_{n}^{f} t w ( t )$$

dt is the expected depth and w defined as per Eq. 5.
h. Grid elasticity regularisation loss. Grid points (xᵢ, yᵢ, zᵢ) for each elastic grid are defined in Eq. 1. Grid locations are typically initialised as a uniform grid with equal distances between all neighbouring grid points. Since they are learnable parameters, grid points can ‘wander’ in the course of model training in order to adaptively devote more capacity to regions of the space that contain more high-detail information. However, in order to prevent degenerate solutions such as grid points collapsing on top of each other we use a Gaussian kernel that introduces a loss if the grid points get too close. For the z direction, the equation is given by

$${L}_{grid} = {\sum }_{i j} {\sum }_{k} exp ( - γ {‖ ( {x}_{i} , {y}_{j} , {z}_{k} ) - ( {x}_{i} , {y}_{j} , {z}_{k + 1} ) ‖}_{2} ) .$$

Here, y is the hyperparameter controlling the strength of the homogenization. To avoid local minima, we initially start with a low parameter in the range of 1e-5 that enforces a more rigid, uniform grid and then successively increase it to allow for more flexibility in the grid. An analogous regularisation is performed along the x and y directions and the loss is calculated for each elastic grid separately.
The individual loss functions are weighted by individual hyperparameters to define their relative strength and then combined into a joint loss function. Stochastic gradient descent is then used to iteratively expose the model to training data and update the weights.
6. Inserting/removing grid points. In addition to the elasticity loss, our model allows for the adaptive addition or removal of grid points. Since insertion and removal are non-differentiable operations, they are performed separately from the backpropagation step that defines most learnable parameters.
   a. Removal. If grid points come very close to each other and their corresponding features in the elastic grid are highly similar, then one of them is considered redundant. Formally, we first identify close grid points, that is, grid points for which ∥(xᵢ, yⱼ, zₖ)−(x_{i′}, y_{j′}, z_{k′})∥₂<ϵ for a distance threshold E. For these points, we then compute the distance of their features ∥φ(xᵢ, yⱼ, zₖ)−φ(x_{i′}, y_{j′}, z_{k′})∥₂, where φ maps a coordinate onto its corresponding feature vector. If the product is below a cutoff value, the grid points are considered mutually redundant and the first one is removed.
   b. Insertion. We construct and maintain a voxel-wise error model V, a 3D volume that maintains a record of the photometric losses in each voxel. Each time photometric loss is computed, all voxels along the corresponding ray are updated with the computed loss. Since objects are seen from different viewpoints, the volume is eventually populated with a voxel-wise error estimate. If a voxel has a large error above a given threshold and has its number of grid points falls below a threshold, a new grid point is created and inserted into the elastic grid. Note that the construction of the error volume imposes additional memory and computation constraints and is thus an optional feature. Even without insertion/removal operations, the elasticity of the grid is assured by the movements of the grid points and the transformations performed by the selector.

An example embodiment of a talking head avatar is shown in (006). The model is trained using a database of talking heads with various poses, facial expressions and identities (006, 1). Images and camera pose estimates are extracted from the data and then normalised to have a coherent coordinate space across all identities. In the training loop, camera pose estimation errors are corrected using our approach outlined above. The selection codes are obtained from an image encoder which is trained alongside with the other model components. The image encoder extracts both static, identity-related features as well as expression-based dynamic features from the input images. The resultant meta model captures both static aspects of the avatars in form of shape and appearance as well as motion primitives captured in a collection of elastic grids (006,2). The neural asset generator can be instantiated by taking a target image and creating a selection code that involves both shape and appearance components (006,3). The selector transforms the code into an animatable 3D head avatar (006,4). Once the neural asset has been obtained it can be animated using the facial expression-based motion code created by the encoder (006,5).

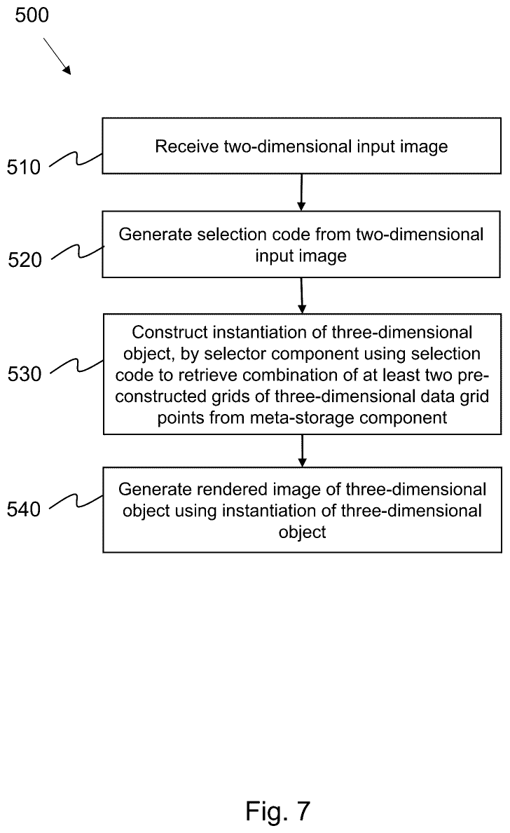

FIG. 7 shows a method 500 for generating a rendered image of a three-dimensional object. The method 500 may be performed by a computing device, according to embodiments. For example, the method 500 may be performed at least in part by a user device, such as a mobile phone, a personal computer, a VR headset, a games console, etc., according to embodiments. The method 500 may be performed at least in part by hardware and/or software. The method is performed using a meta-storage component that contains at least two pre-constructed grids of three-dimensional data grid points corresponding to features of three-dimensional visual representations of a plurality of objects or scenes, and a selector component that queries the meta-storage component.

At item 510, a two-dimensional input image is received. In other embodiments multiple two-dimensional input images may be received. This may include a video being received, the video comprising a plurality of two-dimensional input images. The input image or input images represent a two-dimensional view of the three-dimensional object it is desired to render.

At item 520, a selection code is generated from the two-dimensional input image. The selection code represents the shape and appearance of the three-dimensional object.

At item 530, an instantiation of the three-dimensional object is constructed. The selector component uses the selection code to querying the meta storage component to retrieve a combination of at least two pre-constructed grids of three-dimensional data grid points, which provides the instantiation.

At item 540, a rendered image of the three-dimensional object is generated using the instantiation of the three-dimensional object.

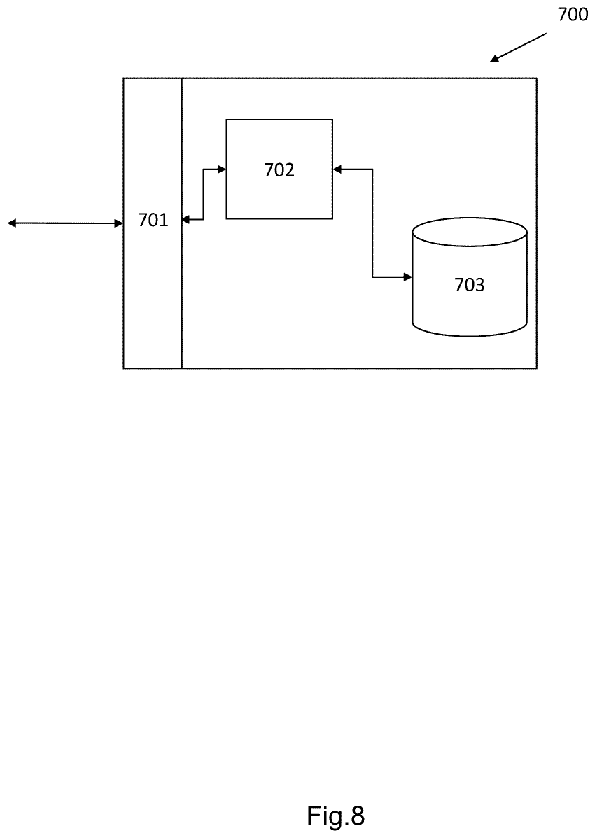

Embodiments of the disclosure include the methods described above performed on a computing device, such as the computing device 700 shown in FIG. 8. The computing device 700 comprises a data interface 701, through which data can be sent or received, for example over a network. The computing device 700 further comprises a processor 702 in communication with the data interface 701, and memory 703 in communication with the processor 702. In this way, the computing device 700 can receive data, such as image data or video data, via the data interface 701, and the processor 702 can store the received data in the memory 703, and process it so as to perform the methods of described herein, including generating rendered images.

Each device, module, component, machine or function as described in relation to any of the examples described herein may comprise a processor and/or processing system or may be comprised in apparatus comprising a processor and/or processing system. One or more aspects of the embodiments described herein comprise processes performed by apparatus. In some examples, the apparatus comprises one or more processing systems or processors configured to carry out these processes. In this regard, embodiments may be implemented at least in part by computer software stored in (non-transitory) memory and executable by the processor, or by hardware, or by a combination of tangibly stored software and hardware (and tangibly stored firmware). Embodiments also extend to computer programs, particularly computer programs on or in a carrier, adapted for putting the above described embodiments into practice. The program may be in the form of non-transitory source code, object code, or in any other non-transitory form suitable for use in the implementation of processes according to embodiments. The carrier may be any entity or device capable of carrying the program, such as a RAM, a ROM, or an optical memory device, etc.

Where in the foregoing description, integers or elements are mentioned which have known, obvious or foreseeable equivalents, then such equivalents are herein incorporated as if individually set forth. Reference should be made to the claims for determining the true scope of the present disclosure, which should be construed so as to encompass any such equivalents. It will also be appreciated by the reader that integers or features of the disclosure that are described as preferable, advantageous, convenient or the like are optional and do not limit the scope of the independent claims. Moreover, it is to be understood that such optional integers or features, whilst of possible benefit in some embodiments of the disclosure, may not be desirable, and may therefore be absent, in other embodiments.

The present disclosure also includes the following clauses:
1. A method to construct a 3D visual neural asset comprising a selector module and a meta-storage component, where
   the meta-storage component contains at least one pre-constructed grid of 3D data grid points corresponding to features of the 3D visual representation of objects or scenes, the selector component constructs an instantiation of a 3D visual asset by:
      querying the meta storage component using a selection code and retrieving at least one combination of at least two data grids from the meta-storage component.
2. A method according to clause 1 where the meta-storage component's elements are constructed by training the features of the 3D data grid points using a database of 3D images of 3D assets using stochastic gradient descent and at least one of the following loss functions: photometric loss, perceptual loss, volumetric loss, sparsity-inducing density loss, GAN loss, VAE loss, depth loss, grid elasticity regularisation loss.
3. A method according to clause 2 where a database of 2D images or videos (containing at least one of RGB data, depth data, RGB-D data) is used and the training of features uses, in addition to its loss functions, a set of camera parameters provided by one of the following:
   camera sensors,
   inferred by a numerical fitting process that estimates them from available training data, computer software approach that generates the artificial 2D images and also includes the associated camera parameters.
4. A method according to clause 1 where the selection code is constructed during training in the form of explicit or implicit embeddings for each of the objects in the training set.
5. A method according to clause 1 where the selection code is generated by a generative model with at least one of Generative Adversarial Network (GAN), Variational Autoencoder (VAE).
6. A method according to clause 1 where the selection code is constructed by encoding at least one input image using as encoder a neural network architecture trained end-to-end along with the other components of our approach.
7. A method according to clause 6 where the encoding is obtained from at least one intermediate layer of a neural network architecture that has been trained for a computer vision task.
8. A method according to clause 6 where the encoder is an external image embedding model.
9. A method according to clause 1 where the generated asset is a Neural Radiance Field (NeRF).
10. A method according to clause 1 where the generated asset is a Signed Distance Function (SDF).
11. A method according to clause 1 where the generated asset is a Neural Radiance Cache.
12. A computer-implemented method to construct a 3D visual neural asset comprising a selector module and a meta-storage component, where
   the meta-storage component contains at least one pre-constructed grid of 3D data grid points corresponding to features of the 3D visual representation of objects or people, the selector component constructs an instantiation of a 3D visual asset by:
      querying the meta storage component using a selection code and retrieving at least one combination of at least two data grids from the meta-storage component.
13. A computing device comprising:
   a processor; and
   a memory,
   wherein the computing device is arranged to perform, using the processor, a method according to any of clauses 1 to 12.
14. A computer program product arranged, when executed on a computing device comprising a processor and memory, to perform a method according to any of clauses 1 to 12.

1. A computer-implemented method for generating a rendered image of a three-dimensional object, using a meta-storage component that contains at least two pre-constructed grids of three-dimensional data grid points corresponding to features of three-dimensional visual representations of a plurality of objects or scenes, the method comprising:
receiving a selection code representing the shape and appearance of the three-dimensional object;
constructing, using a selector component, an instantiation of the three-dimensional object, by querying the meta storage component using the selection code to retrieve at least one combination of at least two pre-constructed grids of three-dimensional data grid points from the meta-storage component; and
generating a rendered image of the three-dimensional object using the instantiation of the three-dimensional object.

2. The method according to claim 1, wherein the pre-constructed grids of three-dimensional data grid points of the meta-storage component are constructed using an artificial neural network, ANN, by training the features of the three-dimensional data grid points using a database of three-dimensional images of three-dimensional objects using stochastic gradient descent and at least one of the following loss functions: photometric loss, perceptual loss, volumetric loss, sparsity-inducing density loss, GAN loss, VAE loss, depth loss, grid elasticity regularisation loss.

3. The method according to claim 2, wherein the features of the three-dimensional data grid points are trained using a database of two-dimensional images or videos containing at least one of RGB data, depth data, RGB-D data, and the training uses, in addition to the loss functions, a set of camera parameters provided by one: camera sensors; inference by a numerical fitting process that estimates the camera parameters from available training data; and computer software that generates artificial two-dimensional images with associated camera parameters.

4. The method according to claim 1, wherein the selection code is generated using an ANN.

5. The method according to claim 4, wherein the ANN uses a generative model with at least one of Generative Adversarial Network (GAN), Variational Autoencoder (VAE).

6. The method according to claim 1, wherein receiving the selection code comprises generating the selection code from at least one input image.

7. The method according to claim 6, wherein the least one input image comprises a two-dimensional view of the three-dimensional object.

8. The method according to claim 6, wherein the selection code is constructed by encoding the least one input image, and wherein the encoding is obtained from at least one intermediate layer of an ANN trained for a computer vision task.

9. The method according to claim 8, wherein the encoder uses an external image embedding model.

10. The method according to claim 1, wherein the instantiation of the three-dimensional object is a Neural Radiance Field.

11. The method according to claim 1, wherein the instantiation of the three-dimensional object is a Signed Distance Function.

12. A computing device comprising:
a processor; and
memory;
wherein the computing device is arranged to perform, using the processor, operations comprising:
generating a rendered image of a three-dimensional object, using a meta-storage component that contains at least two pre-constructed grids of three-dimensional data grid points corresponding to features of three-dimensional visual representations of a plurality of objects or scenes, the operations further comprising:
receiving a selection code representing the shape and appearance of the three-dimensional object;
constructing, using a selector component, an instantiation of the three-dimensional object, by querying the meta storage component using the selection code to retrieve at least one combination of at least two pre-constructed grids of three-dimensional data grid points from the meta-storage component; and
generating a rendered image of the three-dimensional object using the instantiation of the three-dimensional object.

13. The computing device according to claim 12, wherein the pre-constructed grids of three-dimensional data grid points of the meta-storage component are constructed using an artificial neural network, ANN, by training the features of the three-dimensional data grid points using a database of three-dimensional images of three-dimensional objects using stochastic gradient descent and at least one of the following loss functions: photometric loss, perceptual loss, volumetric loss, sparsity-inducing density loss, GAN loss, VAE loss, depth loss, grid elasticity regularisation loss.

14. The computing device according to claim 13, wherein the features of the three-dimensional data grid points are trained using a database of two-dimensional images or videos containing at least one of RGB data, depth data, RGB-D data, and the training uses, in addition to the loss functions, a set of camera parameters provided by one: camera sensors; inference by a numerical fitting process that estimates the camera parameters from available training data;
and computer software that generates artificial two-dimensional images with associated camera parameters.

15. The computing device according to claim 12, wherein the selection code is generated using an ANN.

16. The computing device according to claim 15, wherein the ANN uses a generative model with at least one of Generative Adversarial Network (GAN), Variational Autoencoder (VAE).

17. The computing device according to claim 12, wherein receiving the selection code comprises generating the selection code from at least one input image.

18. The computing device according to claim 17, wherein the least one input image comprises a two-dimensional view of the three-dimensional object.

19. The computing device according to claim 17, wherein the selection code is constructed by encoding the least one input image, and wherein the encoding is obtained from at least one intermediate layer of an ANN trained for a computer vision task.

20. A non-transitory computer-readable medium storing software comprising instructions executable by one or more computers which, upon such execution, cause the one or more computers to perform operations comprising:
generating a rendered image of a three-dimensional object, using a meta-storage component that contains at least two pre-constructed grids of three-dimensional data grid points corresponding to features of three-dimensional visual representations of a plurality of objects or scenes, the operations further comprising:
receiving a selection code representing the shape and appearance of the three-dimensional object;
constructing, using a selector component, an instantiation of the three-dimensional object, by querying the meta storage component using the selection code to retrieve at least one combination of at least two pre-constructed grids of three-dimensional data grid points from the meta-storage component; and
generating a rendered image of the three-dimensional object using the instantiation of the three-dimensional object.
